(19) United States
(12) Patent Application Publication
(10) Pub. No.: US 2017/0260424 A1
(43) Pub. Date: Sep. 14, 2017

(54) COMPOSITE SYSTEM WITH GENTLY ADHERING LINER MATERIAL

(71) Applicant: TESA SE, NORDERSTEDT (DE)

(72) Inventors: UTE ELLRINGMANN, HAMBURG (DE); MARTIN GEELINK, HAMBURG (DE); JIAN YANG-VOSS, HAMBURG (DE)

(73) Assignee: TESA SE, NORDERSTEDT (DE)

(21) Appl. No.: 15/442,914

(22) Filed: Feb. 27, 2017

(30) Foreign Application Priority Data
Mar. 10, 2016 (DE) 10 2016 203 910.5
Nov. 28, 2016 (DE) 10 2016 223 550.8

(51) Int. Cl. C09J 7/02

(52) U.S. Cl. CPC C09J 7/0203; C09J 7/0217; C09J 7/0271; C09J 7/0214; C09J 2433/00; C09J 2423/006; C09J 2407/00; C09J 2205/11

(57) ABSTRACT

A double-sided adhesive tape having a heat-activatable adhesive layer protected with an interliner, in order to allow such tapes to be guided stably over cutting and winding units and also to be stably stored and transported, has a composite system comprising:
an adhesive tape (A) comprising:
   a pressure sensitive adhesive layer, and
   a heat-activatable adhesive layer;
a release liner situated on the pressure sensitive adhesive layer of the tape (A); and
an adhesive tape (B) comprising:
   a carrier layer,
   a release layer on one side of the carrier layer, and
   a pressure sensitive adhesive layer on the side of the carrier layer opposite the release layer and in direct contact with the heat-activatable adhesive layer of tape (A).

Also disclosed is a method for producing a composite system of this kind, and the specific use of the tape (B).

This application claims priority of German Patent Application No. 10 2016 223 550.8, filed on Nov. 28, 2016, which, in turn, claims priority of German Patent Application No. 10 2016 203 910.5, filed on Mar. 10, 2016, the entire contents of which patent applications are incorporated herein by reference.

The invention relates generally to the technical field of adhesive tapes, as used diversely for the temporary or long-term joining or masking of a multiplicity of substrates, such as of structural components. The invention relates more specifically to a composite system which comprises two differently equipped adhesive tapes, with one of the tapes being intended to act as a so-called interliner and to enable substantially the dimensionally stable winding and stable storage of the other tape.

Adhesive tapes frequently comprise a substrate furnished with adhesive on one or both sides. Using the tape allows bonding to be accomplished easily, quickly and now also very powerfully to a range of substrates. The joining task involved is frequently one of uniting substrates of very different kinds. In that case it can be advantageous to have an adhesive tape provided with adhesive on both sides, with the two adhesives having different properties.

Known, for example, are poly(meth)acrylate-based pressure sensitive adhesives which produce high peel adhesion on a range of substrates and, moreover, are notable for the long-term stability of the adhesive bond under different external conditions.

Alternatively, heat-activatable adhesives have also come under the spotlight. These frequently comprise polyolefins, which in particular allow powerful adhesive bonds on both thermoplastic and thermoset substrates. In the case of thermoplastic substrates, not only the adhesive but also the substrate may be in a melted or softened state, and so the materials may penetrate one another superficially. This results in highly stable bonds after cooling. In the case of thermoset substrates, the melted, heat-activated adhesive is able to wet the substrate very effectively, likewise resulting in high peel adhesion after cooling.

Double-sided adhesive tapes with different adhesives are described in EP 0 384 598 A1, for example. Specifically the text discloses an adhesive tape having a layer comprising a heat-activatable polyolefin adhesive, to which a polymer of selected acrylic monomers has been applied by means of graft polymerization. The adhesive tape further comprises a UV-polymerized, pressure-sensitive acrylate adhesive layer which adheres to the heat-activatable layer even on exposure to heat.

A similar construction is described in U.S. Pat. No. 4,563,388 A.

EP 1 262 532 A1 describes an adhesive tape which comprises a heat-activatable adhesive layer based on a polymer of one or more olefin monomers, and a pressure sensitive adhesive layer based on a pressure sensitive polyacrylate adhesive. The pressure sensitive adhesive layer is bonded directly and durably to the heat-activatable layer.

Adhesive tapes coated on one or both sides with adhesives usually end their production process by being wound up to form a roll or a reel. To prevent the pressure sensitive adhesives coming into contact with one another, in the case of double-sided adhesive tapes, or to ensure easier unwind, in the case of single-sided adhesive tapes, the adhesive is covered, before the adhesive tape is wound, with a liner material (also termed release material). Such liner materials are known as liners or release liners. In addition to the lining of single-sided or double-sided adhesive tapes, liners are also used for enveloping labels. A further function of these release liners is to prevent soiling of the adhesive prior to application. Via the nature and composition of the release materials, release liners may additionally be formulated to allow the adhesive tape to be unwound with the desired force (easy or difficult). In the case of adhesive tapes coated with adhesive on both sides, the release liners additionally ensure that the correct side of the adhesive is exposed first during unwind.

A liner or release liner is not a constituent of an adhesive tape or label, but instead is only an auxiliary to its production, storage, or for its further processing by diecutting. Furthermore, unlike an adhesive tape carrier, a liner is not permanently joined to an adhesive layer.

Double-sided adhesive tapes which comprise a pressure sensitive adhesive layer and a heat-activatable adhesive layer, and whose pressure sensitive adhesive layer is lined with a release liner, are generally wound to form a lattice-wound long roll, also called reel, and are therefore frequently provided with a further release liner on the side of the heat-activatable layer, during their production and storage. This further release liner, often referred to as “auxiliary liner” or else as “interliner”, overhangs the width of the adhesive tape on both sides, in general, and is therefore able, among other things, to prevent the side edges of the wound adhesive tape from sticking to one another, also called blocking.

The adhesive tapes described, comprising a heat-activatable adhesive layer and a pressure sensitive adhesive layer lined with a release liner, also have the feature, however, that the assembly formed of adhesive tape and release liner on the pressure sensitive adhesive side is non-tacky on both sides. Where an assembly of this kind, with interliner situated on the side of the heat-activatable layer, passes in the form of a web through a cutting mechanism and/or where such an assembly is wound to a reel, it frequently cannot be guided stably on its path. At deflecting rollers and over relatively long unguided sections, in particular, the interliner separates from the rest of the assembly. Furthermore, during storage and transport of the adhesive tapes, there is often slipping of the interliners and, consequently, instances of damage to the adhesive tape surfaces.

It is an object of the present invention to provide a remedy here and to avoid the disadvantages just described. The intention in particular is to make it possible to provide double-sided adhesive tapes, having a heat-activatable adhesive layer and a pressure sensitive adhesive side provided with a conventional release liner, with protection on the heat-activatable side by an interliner, without adversely affecting the stability of travel through the customary cutting and winding units. A further intention is to allow these adhesive tapes to be stored stably and transported stably, and to minimize the risk of surface damage.

A first and general subject of the invention is a composite system which comprises
an adhesive tape (A) which comprises
   a pressure sensitive adhesive layer and
   a heat-activatable adhesive layer;
a release liner situated on the pressure sensitive adhesive layer of the tape (A); and
an adhesive tape (B) which comprises
   a carrier material,
   a release layer on one side of the carrier material, and
   a pressure sensitive adhesive layer on the side of the carrier material opposite from the release layer;
      where the pressure sensitive adhesive layer of the tape (B) is in direct contact with the heat-activatable adhesive layer of the tape (A), and the tape (B) has a peel adhesion of not more than 5 N/cm, determined to EN 1939:2003, to the heat-activatable adhesive layer of the tape (A).

A system of this kind therefore comprises a double-sided adhesive tape with a pressure sensitive adhesive and with a heat-activatable adhesive, and also a release liner situated on the pressure sensitive adhesive, and an adhesive tape which adheres gently to the heat-activatable adhesive, has a release coating on its reverse and therefore functions as an interliner in the sense described above. The single-sidedly—albeit comparatively gently—adhesively equipped interliner produces, advantageously, a substantially more stable bond between the interliner and the heat-activatable layer, which is non-tacky at room temperature under conventional storage temperatures, meaning that slipping of the interliner and the consequent possibility of damage to the surface of the double-sided adhesive tape during guiding through cutting and winding units and also during transport and storage becomes substantially more difficult. Nevertheless, the interliner continues to fulfil its actual function, namely of protecting the side edges of the double-sided adhesive tape prior to bonding, and can be removed from the double-sided adhesive tape with minimal application of force before said tape is applied.

In accordance with the invention, as customary in the general linguistic usage, a pressure sensitive adhesive or pressure-sensitive adhesive (PSA) is understood to be a substance which at least at room temperature is durably tacky and also adhesive. Characteristic of a PSA is that it can be applied to a substrate by means of pressure, and remains adhering there, with the pressure to be employed and the duration of that pressure not being defined in more detail. Generally speaking, though fundamentally dependent on the precise nature of the PSA, the temperature and the atmospheric humidity, and of the substrate, a minimal pressure acting for a short time, which does not go beyond gentle contact for a brief moment, is sufficient to obtain the adhesion effect; in other cases, a longer-term duration of exposure to a higher pressure may be necessary.

PSAs have particular, characteristic viscoelastic properties which result in the durable tack and adhesiveness. Characteristically, when PSAs are mechanically deformed, there are viscous flow processes and there is also development of elastic restorative forces. In terms of their respective proportion, the two processes are in a particular relationship with one another, dependent not only on the precise composition, structure and degree of crosslinking of the PSA but also on the rate and duration of the deformation, and on the temperature. The proportion of viscous flow is necessary for the achievement of adhesion. Only the viscous components, produced by macromolecules with relatively high mobility, allow effective wetting and effective flow onto the substrate to be bonded. A high viscous flow component results in high pressure-sensitive adhesiveness (also referred to as tack or surface tackiness) and hence often also in a high peel adhesion. Owing to a lack of flowable components, highly crosslinked systems and polymers which are crystalline or which have undergone glasslike solidification generally have at least only a little tack, or none at all.

The proportional elastic restorative forces are necessary for the achievement of cohesion. They are brought about, for example, by very long-chain, highly entangled macromolecules and also by physically or chemically crosslinked macromolecules, and they permit the transmission of the forces engaging on an adhesive bond. Their result is that an adhesive bond is able to withstand sufficiently over a prolonged time period a long-term load acting on it, in the form for example of a sustained shearing load.

For more precise description and quantification of the extent of elastic and viscous components, and also of the ratio of the components to one another, the variables of storage modulus (G′) and loss modulus (G″) are employed, and can be determined by Dynamic Mechanical Analysis (DMA). G′ is a measure of the elastic fraction, G″ a measure of the viscous fraction, of a substance. Both variables are dependent on the deformation frequency and the temperature.

The variables can be determined by means of a rheometer. In this case, the material for analysis is exposed to a sinusoidally oscillating shearing stress in—for example—a plate/plate arrangement. In the case of instruments operating with shear stress control, measurements are made of the deformation as a function of time, and of the time offset of that deformation relative to the introduction of the shearing stress. This time offset is identified as phase angle δ.

The storage modulus G′ is defined as follows: G′=(τ/γ) ·cos(δ) (τ=shearing stress, γ=deformation, δ=phase angle=phase shift between shear stress vector and deformation vector). The definition of the loss modulus G″ is as follows: G″=(τ/γ) ·sin(δ) (τ=shearing stress, γ=deformation, δ=phase angle=phase shift between shear stress vector and deformation vector).

A composition is considered in general to be a PSA and is defined as such for the purposes of the invention if at 23° C. in the deformation frequency range from 10⁰ to 10¹ rad/sec, both G′ and G″ are situated at least partly in the range from 10³ to 10⁷ Pa. “Partly” means that at least a section of the G′ plot is within the window subtended by the deformation frequency range of from 10⁰ inclusive to 10¹ (inclusive) rad/sec (abscissa) and also the range of the G′ values from 10³ (inclusive) to 10⁷ (inclusive) Pa (ordinate) and when at least a section of the G″ plot is likewise within the corresponding window.

The material basis for the pressure sensitive adhesive layer of adhesive tape (A) (hereinafter also referred to synonymously as “PSA of tape (A)”) is fundamentally arbitrary, provided that compatibility with the other components of the composite system of the invention, and function as pressure sensitive adhesive, are ensured.

The PSA layer of tape (A) preferably comprises poly(meth)acrylate as principal constituent. By “poly(meth)acrylate” is meant a polymer whose monomer basis consists to an extent of at least 70 wt % of acrylic acid, methacrylic acid, acrylic esters and/or methacrylic esters, with acrylic esters and/or methacrylic esters being present at not less than 50 wt %, based in each case on the overall monomer composition of the polymer in question. Poly(meth)acrylates are obtainable generally by radical polymerization of acrylic and/or methylacrylic monomers and also, optionally, other copolymerizable monomers. In accordance with the invention, the term “poly(meth)acrylate” embraces not only polymers based on acrylic acid and derivatives thereof but also those based on acrylic acid and methacrylic acid and derivatives thereof, and polymers based on methacrylic acid and derivatives thereof. The PSA of tape (A) may comprise one or more poly(meth)acrylates. Where there are two or more poly(meth)acrylates present, “principal constituent” relates to the entirety of the poly(meth)acrylates.

A poly(meth)acrylate-based PSA has advantageously high peel adhesion relative to a series of substrates, and is notable, moreover, for high stability towards environmental influences and also over long periods of time.

Adhesive tape (A) preferably comprises a foamed pressure sensitive adhesive layer (also referred to hereinafter, synonymously, as “foamed PSA” or “foamed pressure sensitive adhesive of tape (A)”). A “foamed PSA” is a pressure sensitive adhesive which comprises a pressure-sensitive adhesive matrix material and a plurality of gas-filled cavities, thereby reducing the density of this PSA by comparison with the plain matrix material without cavities. Foaming of the matrix material of the foamed PSA may be accomplished in principle in any desired way. The foamed pressure sensitive adhesive layer of tape (A) preferably comprises at least partially expanded hollow microbeads. These are at least partially expanded microbeads which in their basic state are elastic and expandable and have a thermoplastic polymer shell. These spheres—in the basic state—are filled with low-boiling liquids or liquefied gas. Shell materials used include, in particular polyacrylonitrile, PVDC, PVC or polyacrylates. Customary low-boiling liquids are, in particular, hydrocarbons of the lower alkanes, such as isobutene or isopentane, and are enclosed in the form of liquefied gas under pressure in the polymer shell. For microspheres of this kind, the term “microballoons” is also customary.

Exposure of the microballoons to heat causes the outer polymers shell to soften. At the same time, the propellant gas in liquid form within the shell undergoes transition to its gaseous state. When this occurs, the microballoons stretch irreversibly and undergo three-dimensional expansion. Expansion is at an end when the internal and external pressures match one another. Since the polymeric shell is retained, the result is a closed-cell foam.

A multiplicity of types of microballoon are available commercially, and differ essentially in their size (6 to 45 μm in diameter in the unexpanded state) and in the onset temperatures they require for expansion (75 to 220° C.). Unexpanded microballoon types are also available in the form of an aqueous dispersion with a solids fraction or microballoon fraction of around 40 to 45 wt %, and are additionally available as polymer-bound microballoons (masterbatches), in ethylene-vinyl acetate, for example, with a microballoon concentration of around 65 wt %. The microballoon dispersions and the masterbatches, like the unexpanded microballoons, are suitable as such for producing the foamed PSA of tape (A) of the invention.

The foamed PSA may also be generated using what are called preexpanded hollow microspheres. With this group, the expansion takes place prior to incorporation into the polymer matrix.

With preference in accordance with the invention, the foamed PSA layer of adhesive tape (A) comprises at least partially expanded hollow microspheres, irrespective of the mode of preparation and of the form in which the hollow microspheres are used. With particular preference at least 90% of all the cavities in the foamed PSA of tape (A), formed by the hollow microspheres, have a maximum extent of 10 to 500 μm, more preferably of 15 to 200 μm.

The term “at least partially expanded hollow microspheres” is understood in accordance with the invention to mean that the hollow microspheres have undergone expansion at least to a degree such as to bring about a reduction in the density of the PSA to a technically meaningful extent by comparison with the same adhesive with the unexpanded hollow microspheres. This means that the microballoons need not necessarily have undergone complete expansion. The “at least partially expanded hollow microspheres” have preferably expanded in each case to at least twice their maximum extent in the unexpanded state.

The expression “at least partially expanded” relates to the expanded state of the individual hollow microspheres and is not intended to mean that only some of the hollow microspheres in question must have undergone (initial) expansion. If, therefore, there are “at least partially expanded hollow microspheres” and unexpanded hollow microspheres present in the adhesive, this means that unexpanded (totally unexpanded, in other words having not undergone even initial expansion) hollow microspheres do not belong to the “at least partially expanded hollow microspheres”.

The foamed PSA of tape (A) preferably comprises poly(meth)acrylate as principal constituent. This is to be understood as described above for the PSA of tape (A).

The poly(meth)acrylate of the foamed pressure sensitive adhesive of adhesive tape (A) may preferably be traced back to the following monomer composition:
a) acrylic esters and/or methacrylic esters of the formula (I)

CH₂═C(R′)(COOR″) (I),

in which R′ is H or CH₃ and R″ is an alkyl radical having 4 to 14 C atoms, more preferably having 4 to 9 C atoms;
b) olefinically unsaturated monomers having functional groups which exhibit reactivity with crosslinker substances;
c) optionally further olefinically unsaturated monomers which are copolymerizable with the monomers (a) and (b).

The proportions of the monomers a), b) and c) are selected with particular preference such that the poly(meth)acrylate has a glass transition temperature of ≦15° C. (DMA at low frequencies). For this purpose it is advantageous to select the monomers a) with a proportion of 45 to 99 wt %, the monomers b) with a proportion of 1 to 15 wt %, and the monomers c) with a proportion of 0 to 40 wt %, based in each case on the overall monomer composition of the poly(meth)acrylate.

The monomers a) are more preferably plasticizing and/or apolar monomers. Preferably, therefore, the monomers a) are selected from the group encompassing n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate, isobutyl acrylate, isooctyl acrylate, isooctyl methacrylate, 2-ethylhexyl acrylate and 2-ethylhexyl methacrylate.

The monomers b) are preferably olefinically unsaturated monomers having functional groups which are able to enter into a reaction with epoxide groups. More preferably the monomers b) each contain at least one functional group selected from the group consisting of hydroxyl, carboxyl, sulphonic acid and phosphonic acid groups, acid anhydride functions, epoxide groups, and substituted or unsubstituted amino groups.

In particular the monomers b) are selected from the group consisting of acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, 2-hydroxyethyl acrylate, 3-hydroxypropyl acrylate, 2-hydroxyethyl methacrylate, 3-hydroxypropyl methacrylate, 6-hydroxyhexyl methacrylate, allyl alcohol, glycidyl acrylate and glycidyl methacrylate.

Contemplated as monomers c) in principle are all vinylically functionalized compounds which are copolymerizable with the monomers a) and with the monomers b). Through selection and amount of the monomers c) it is possible advantageously to regulate properties of the foamed pressure sensitive adhesive of adhesive tape (A).

The monomers c) are more preferably selected from the group consisting of methyl acrylate, ethyl acrylate, n-propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxypolyethylene glycol methacrylate 350, methoxypolyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexa-fluoroisopropyl acrylate, 1,1,1,3,3,3-hexafluoroisopropyl methacrylate, 2,2,3,3,3-pentafluoro-propyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-penta-decafluorooctyl methacrylate, dimethylaminopropylacrylamide, dimethylaminopropylmeth-acrylamide, N-(1-methylundecyl)acrylamide, N-(n-butoxymethyl)acrylamide, N-(butoxy-methyl)methacrylamide, N-(ethoxymethyl)acrylamide, N-(n-octadecyl)acrylamide, N,N-dialkyl-substituted amides, more particularly N,N-dimethylacrylamide, N,N-dimethyl-methacrylamide, N-benzylacrylamide, N-isopropylacrylamide, N-tert-butylacrylamide, N-tert-octylacrylamide, N-methylolacrylamide, N-methylolmethacrylamide; additionally acrylonitrile, methacrylonitrile; vinyl ethers such as vinyl methyl ether, ethyl vinyl ether, vinyl isobutyl ether; vinyl esters such as vinyl acetate; vinyl chloride, vinyl halides, vinylidene halides, vinylpyridine, 4-vinylpyridine, N-vinylphthalimide, N-vinyllactam, N-vinylpyrrolidone, styrene, αand ρ-methylstyrene, α-butylstyrene, 4-n-butylstyrene, 4-n-decylstyrene, 3,4-dimethoxy-styrene, 2-polystyrene-ethyl methacrylate (molecular weight Mw of 4000 to 13 000 g/mol) and poly(methyl methacrylate)-ethyl methacrylate (Mw of 2000 to 8000 g/mol).

The monomers c) may advantageously also be selected such that they contain functional groups which support radiation-chemical crosslinking (by electron beams or UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide and allyl acrylate.

With particular preference, where the foamed pressure sensitive adhesive of adhesive tape (A) comprises a plurality of poly(meth)acrylates, all poly(meth)acrylates in the foamed pressure sensitive adhesive of adhesive tape (A) can be traced back to the above-described monomer composition. More particularly all poly(meth)acrylates in the foamed pressure sensitive adhesive of adhesive tape (A) can be traced back to a monomer composition consisting of acrylic acid, n-butyl acrylate and methyl acrylate.

In particular, the poly(meth)acrylate and/or all poly(meth)acrylates in the foamed pressure sensitive adhesive of adhesive tape (A) can be traced back to the following monomer composition:

| | |
|---|---|
| Acrylic acid | 3-15 wt % |
| Methyl acrylate | 10-35 wt % |
| 2-Ethylhexyl acrylate | 50-87 wt %, |

the proportions of the monomers adding up to 100 wt %.

The poly(meth)acrylates can be prepared by radical polymerization of the monomers in solvents, more particularly in solvents having a boiling range of 50 to 150° C., preferably of 60 to 120° C., using the customary amounts of polymerization initiators, which are in general 0.01 to 5, more particularly 0.1 to 2 wt % (based on the total weight of the monomers).

Suitable in principle are all customary initiators familiar to the skilled person. Examples of radical sources are peroxides, hydroperoxides and azo compounds, as for example dibenzoyl peroxide, cumene hydroperoxide, cyclohexanone peroxide, di-tert-butyl peroxide, cyclohexylsulphonyl acetyl peroxide, diisopropyl percarbonate, tert-butyl peroctoate, benzopinacol. One very preferred procedure uses 2,2′-azobis(2-methylbutyronitrile) or 2,2′-azobis(2-methylpropionitrile) (2,2′-azobisisobutyronitrile; AIBN) as radical initiator.

Solvents contemplated for preparing the poly(meth)acrylates include alcohols such as methanol, ethanol, n-propanol and isopropanol, n-butanol and isobutanol, preferably isopropanol and/or isobutanol, and also hydrocarbons such as toluene and, in particular, benzines from a boiling range of 60 to 120° C. Additionally it is possible to use ketones such as preferably acetone, methyl ethyl ketone, methyl isobutyl ketone, and esters such as ethyl acetate, and also mixtures of solvents of the type stated, preference being given to mixtures which include isopropanol, more particularly in amounts of 2 to 15 wt %, preferably 3 to 10 wt %, based on the solvent mixture used.

With preference in accordance with the invention, after the preparation (polymerization) of the poly(meth)acrylates, there is a concentration procedure, and the further processing of the poly(meth)acrylates is substantially solvent-free. The polymer can be concentrated in the absence of crosslinker and accelerator substances. It is also possible, however, for one of these classes of substance to be added to the polymer even prior to concentration, in which case the concentration takes place in the presence of this or these substance(s).

After the concentration step, the polymers can be transferred to a compounder. Concentration and compounding may optionally also take place in the same reactor.

The weight-average molecular weights M_{w} of the poly(meth)acrylates in the foamed pressure sensitive adhesive of adhesive tape (A) are situated preferably in a range from 20 000 to 2 000 000 g/mol, very preferably in a range from 100 000 to 1 500 000 g/mol, most preferably in a range from 150 000 to 1 000 000 g/mol. The figures for average molecular weight M_{w} and for polydispersity PD in this specification relate to the determination by gel permeation chromatography. It may be advantageous to carry out the polymerization in the presence of suitable chain transfer agents such as thiols, halogen compounds and/or alcohols in order to set the desired average molecular weight.

The poly(meth)acrylate preferably has a K value of 30 to 90, more preferably of 40 to 70, as measured in toluene (1% strength solution, 21° C.). The K value of Fikentscher is a measure of the molecular weight and the viscosity of the polymer.

Likewise suitable in accordance with the invention are poly(meth)acrylates which have a narrow molecular weight distribution (polydispersity PD<4). In spite of a relatively low molecular weight, these compositions have particularly good shear strength after crosslinking. Moreover, the lower polydispersity makes processing from the melt easier, since the flow viscosity is lower than that of a more broadly distributed poly(meth)acrylate, for largely the same service properties. Narrowly distributed poly(meth)acrylates may be prepared advantageously by anionic polymerization or by controlled radical polymerization methods, the latter being especially suitable. Via N-oxyls as well it is possible to prepare corresponding poly(meth)acrylates. Besides these methods, Atom Transfer Radical Polymerization (ATRP) can be employed advantageously for the synthesis of narrowly distributed polyacrylates, in which case the initiator used preferably comprises monofunctional or difunctional, secondary or tertiary halides, with the halides being abstracted using Cu, Ni, Fe, Pd, Pt, Ru, Os, Rh, Co, Ir, Ag or Au complexes.

The poly(meth)acrylate(s) in the foamed pressure sensitive adhesive of adhesive tape (A) is/are preferably crosslinked. While thick layers of composition are hard to crosslink homogeneously via conventional electron beam or UV radiation treatment, owing to the rapidly decreasing radiation intensity with increasing depth of penetration, thermal crosslinking provides sufficient remedy for this situation. Preferably, therefore, the foamed pressure sensitive adhesive of adhesive tape (A) is crosslinked thermally. Layers of compositions considered to be thick are more particularly those with a thickness of more than 150 μm.

The poly(meth)acrylates in the foamed pressure sensitive adhesive layer of adhesive tape (A) are crosslinked preferably with isocyanates, more particularly with trimerized isocyanates and/or blocking-agent-free and sterically hindered isocyanates, and/or with epoxide compounds, in each case in the presence of functional groups in the polymer macromolecules that are able to react with isocyanate groups and/or epoxide groups, respectively.

In order to attenuate the reactivity of the isocyanates, it is possible advantageously to use isocyanates blocked with thermally eliminable functional groups. Blocking takes place preferably using aliphatic primary and secondary alcohols, phenol derivatives, aliphatic primary and secondary amines, lactams, lactones and malonic esters.

Where epoxy-amine systems are used as crosslinker systems, the amines can be converted into their salts in order to ensure an increase in the pot life. In this case readily volatile organic acids (e.g. formic acid, acetic acid) or readily volatile mineral acids (e.g. hydrochloric acid, derivatives of carbonic acid) are preferred for salt formation.

A fundamental problem when using thermal crosslinkers in the preparation of the foamed pressure sensitive adhesive of adhesive tape (A) arises from the increase in temperature that is needed for the expansion of the microballoons. The choice of the relatively slow-to-react crosslinkers identified above, particularly preferably together with accelerator systems for regulating the kinetics of the crosslinking reaction, is particularly advantageous, since with these crosslinkers it is possible to employ the temperatures needed for foaming, without the adhesive system suffering damage.

Having been found particularly preferable for the foamed pressure sensitive adhesive of adhesive tape (A) is a crosslinker-accelerator system which comprises at least one crosslinker substance containing epoxide groups and at least one accelerator substance with an effect of accelerating the linking reaction at a temperature below the melting temperature of the poly(meth)acrylate. The system presupposes the presence in the polymers of functional groups which are able to enter into crosslinking reactions with epoxide groups. Suitable substances containing epoxide groups include polyfunctional epoxides, especially difunctional or trifunctional epoxides (i.e. those having two or three epoxide groups, respectively), or else epoxides of higher functionality, or mixtures of epoxides with different functionalities. Accelerators used are preferably amines (to be interpreted formally as substitution products of ammonia), examples being primary and/or secondary amines, especially tertiary and/or polyfunctional amines. Also possible for use are substances which have two or more amine groups, these amine groups being primary and/or secondary and/or tertiary amine groups, more particularly diamines, triamines and/or tetramines. Selected more particularly are those amines which enter into no reactions or only minor reactions with the polymer building blocks. Further examples of accelerators which can be used are phosphorus-based accelerators, such as phosphines and/or phosphonium compounds.

Particularly suitable functional groups in the poly(meth)acrylate for crosslinking include acid groups (for example carboxylic, sulphonic and/or phosphonic acid groups) and/or hydroxyl groups and/or acid anhydride groups and/or epoxide groups and/or amine groups. It is particularly advantageous if the polymer comprises copolymerized acrylic acid and/or methacrylic acid.

It may, however, also be advantageous not to include accelerators, since they may have a tendency, for example, towards yellowing (especially nitrogen-containing substances). Examples of suitable crosslinkers which work without addition of accelerator include epoxycyclohexyl derivatives, especially when carboxylic acid groups are present in the poly(meth)acrylate for crosslinking. This may be realized for example by at least 5 wt % copolymerized acrylic acid into the polymer. In the polymer for crosslinking there are advantageously, in particular, no proton acceptors, no electron-pair donors (Lewis bases) and/or no electron-pair acceptors (Lewis acids) present. The absence of these substances relates here in particular to externally added accelerators, in other words not copolymerized accelerators and/or accelerators incorporated into the polymer framework; with particular preference, however, there are neither externally added nor copolymerized accelerators present, and especially no accelerators at all. Crosslinkers which have emerged as being particularly advantageous are epoxycyclohexylcarboxylates such as (3,4-epoxycyclo-hexane)methyl 3,4-epoxycyclohexylcarboxylate.

Besides the poly(meth)acrylate(s), the foamed pressure sensitive adhesive of adhesive tape (A) may also comprise one or more further polymers. These include, for example, acrylate-insoluble polymers such as polyolefins (e.g. LDPE, HDPE, polypropylene), polyolefin copolymers (e.g. ethylene-propylene copolymers), polyesters, copolyesters, polyamides, copolyamides, fluorinated polymers, polyalkylene oxides, polyvinyl alcohol, ionomers (for example, ethylene-methacrylic acid copolymers neutralized with base), cellulose acetate, polyacrylonitrile, polyvinyl chloride, thermoplastic polyurethanes, polycarbonates, ABS copolymers and polydimethylsiloxanes. Further suitable polymers are polybutadiene, polyisoprene, polychloroprene and copolymers of styrene and dienes. Additionally suitable are polymers which are inherently pressure-sensitively adhesive or which can be rendered pressure-sensitively adhesive through the addition of bond strength enhancers, examples of such polymers being poly-a-olefins such as polyoctene, polyhexene and atactic polypropylene; specific block copolymers (diblock, triblock, star-shaped block copolymers and combinations thereof), natural and synthetic rubbers, silicones and ethylene-vinyl acetate.

In one specific embodiment the foamed pressure sensitive adhesive of adhesive tape (A) comprises 15 to 50 wt % of at least one synthetic rubber. Synthetic rubber is included preferably at 20 to 40 wt %, based in each case on the total weight of the pressure sensitive adhesive.

Preferably in this embodiment at least one synthetic rubber in the foamed pressure sensitive adhesive of adhesive tape (A) is a block copolymer having an A-B, A-B-A, (A-B)ₙ, (A-B)ₙX or (A-B-A)ₙX construction,

in which
the blocks A independently of one another are a polymer formed by polymerization of at least one vinylaromatic;
the blocks B independently of one another are a polymer formed by polymerization of conjugated dienes having 4 to 18 C atoms and/or isobutylene, or are a partly or fully hydrogenated derivative of such a polymer;
X is the residue of a coupling reagent or initiator; and
n is an integer ≧2.

In particular in this embodiment all synthetic rubbers in the foamed pressure sensitive adhesive of adhesive tape (A) are block copolymers having a construction as set out above. The foamed pressure sensitive adhesive of adhesive tape (A) may therefore also comprise mixtures of different block copolymers having a construction as above.

Suitable block copolymers (vinylaromatic block copolymers) thus comprise preferably one or more rubberlike blocks B (soft blocks) and one or more glasslike blocks A (hard blocks). More preferably at least one synthetic rubber in the foamed pressure sensitive adhesive of adhesive tape (A) is a block copolymer having an A-B, A-B-A, (A-B)₃X or (A-B)₄X construction, where A, B and X are as defined above. Very preferably all synthetic rubbers in the foamed pressure sensitive adhesive of adhesive tape (A) are block copolymers having an A-B, A-B-A, (A-B)₃X or (A-B)₄X construction, where A, B and X are as defined above. More particularly the synthetic rubber in the foamed pressure sensitive adhesive of adhesive tape (A) is a mixture of block copolymers having an A-B, A-B-A, (A-B)₃X or (A-B)₄X construction which preferably comprises at least diblock copolymers A-B and/or triblock copolymers A-B-A.

Block A is generally a glasslike block having a preferred glass transition temperature (Tg, DSC) which is above room temperature. More preferably the Tg of the glasslike block is at least 40° C., more particularly at least 60° C., very preferably at least 80° C. and most preferably at least 100° C. The proportion of vinylaromatic blocks A in the overall block copolymers is preferably 10 to 40 wt %, more preferably 20 to 33 wt %. Vinylaromatics for the construction of block A include preferably styrene, a-methylstyrene and/or other styrene derivatives. Block A may therefore be a homopolymer or copolymer. More preferably block A is a polystyrene.

The vinylaromatic block copolymer additionally generally has a rubberlike block B or soft block having a preferred Tg of less than room temperature. The Tg of the soft block is more preferably less than 0° C., more particularly less than −10° C., as for example less than −40° C., and very preferably less than −60° C.

Preferred conjugated dienes as monomers for the soft block B are, in particular, selected from the group consisting of butadiene, isoprene, ethylbutadiene, phenylbutadiene, piperylene, pentadiene, hexadiene, ethylhexadiene, dimethylbutadiene and the farnesene isomers, and also any desired mixtures of these monomers. Block B as well may be a homopolymer or copolymer.

The conjugated dienes as monomers for the soft block B are more preferably selected from butadiene and isoprene. For example, the soft block B is a polyisoprene, a polybutadiene or a partly or fully hydrogenated derivative of one of these two polymers, such as polybutylenebutadiene in particular; or a polymer of a mixture of butadiene and isoprene. Very preferably the block B is a polybutadiene.

The PSA layer necessarily present in adhesive tape (A) may be, but need not be, identical to the foamed PSA layer of tape (A) that is preferably present. The “PSA layer of tape (A)” and the wording “adhesive tape (A) comprising a pressure sensitive adhesive layer” mean that the pressure-sensitive adhesive properties of this PSA layer may be active outwardly, i.e. towards a substrate. Accordingly, this PSA layer does not join two other layers of adhesive tape (A) to one another, but should instead be seen as an outer layer of adhesive tape (A).

In one embodiment, adhesive tape (A) comprises a foamed pressure sensitive adhesive layer, and the foamed pressure sensitive adhesive layer is the pressure sensitive layer of tape (A). This is advantageous because the foamed PSA is capable of compensating unevennesses on the substrate surface and hence of producing uniform adhesive bonds even on such surfaces.

In another embodiment, the adhesive tape (A) comprises a foamed pressure sensitive adhesive layer, and the foamed pressure sensitive adhesive layer of tape (A) is a carrier material with the heat-activatable adhesive layer on one side thereof and the pressure sensitive adhesive layer on the other side thereof. This is advantageous since positive properties of the foamed carrier material can be combined with those of the PSA and in this way very highly performing adhesive layers can be obtained.

A “heat-activatable adhesive layer” (also referred to synonymously below as “heat-activatable adhesive”) refers to a layer of an adhesive which is not tacky at room temperature and which only on heating is able to develop adhesion to a substrate sufficiently to bring about an adhesive bond to that substrate. “Heating” refers customarily to exposure to a temperature in the range from about 60 to about 200° C., more particularly in accordance with the invention in the range from 120° C. to 200° C.

The heat-activatable adhesive layer of tape (A) is preferably a polyolefin layer. The polyolefin may derive from one or more olefin monomers. The material of the heat-activatable adhesive layer is preferably selected from polyethylene, polypropylene, ethylene-propylene copolymers and mixtures of these polymers. More preferably the material of the heat-activatable adhesive layer is polypropylene.

The adhesive tape (A) is used preferably for bonding plastics parts to glass or painted substrates, in car making, for example. The adhesive tape (A) may be used, for example, for bonding what are called weather strips. With particular preference the adhesive tape (A) is used for bonding plastics profiles to glass sheets or bodywork parts of vehicles, particularly for bonding seals in the door region and/or for bonding rubber lips and other polymeric lips on glass sheets.

The composite system of the invention further comprises a release liner situated on the pressure sensitive adhesive layer of tape (A). As far as the invention is concerned, the construction of this release liner is not critical. Suitable in principle is any release liner which is able to take on the customary protective function for the PSA of adhesive tape (A), and which does not significantly adversely affect the PSA and the other components of the composite system, and can be removed from the PSA in a customary way prior to application.

Suitable release coatings for the release liner include all of the systems known to the skilled person, examples being silicones, fluorinated silicones, silicone copolymers, waxes, carbamates, polyolefins, or mixtures of two or more of the said substances.

The composite system of the invention further comprises an adhesive tape (B) which comprises a carrier layer, a release layer on one side of the carrier layer, and a pressure sensitive adhesive layer on the side of the carrier layer opposite from the release layer.

Adhesive tape (B) is preferably wider than adhesive tape (A) and wider than the release liner situated on its pressure sensitive adhesive layer, and likewise preferably overhangs on both sides of the adhesive tape (A) and of the release liner. This means that to the left and right of the web course of tape (A), adhesive tape (B) fully covers tape (A) and the release liner situated on the PSA of tape (A), and also reaches out over the side edges thereof. Tape (B) therefore functions as an “interliner” in the sense described above. The overhang need not necessarily be of equal extent on both sides of tape (A) and of the release liner; in other words, “asymmetrical overage” of this composite by tape (B) is also possible.

Suitable material for the carrier layer of tape (B) includes in principle any material which is suitable as a carrier for a PSA and a release coating and, furthermore, is sufficiently flexible that it can be wound up to a reel without problems. The carrier layer of tape (B) is preferably a polyolefin film, more particularly a polypropylene film, as for example a film composed of monoaxially oriented polypropylene (MOPP).

Applied on one side of the carrier layer of tape (B) there is a release layer. Suitable systems for this release layer include all those known to the skilled person, examples being silicones, fluorinated silicones, silicone copolymers, waxes, carbamates, polyolefins or mixture of two or more of said systems.

Additionally, tape (B) comprises a pressure sensitive adhesive layer on the side of the carrier layer opposite the release layer. In principle the design and the materials basis for the layer of pressure sensitive adhesive are arbitrary, provided that the tape (B) via its pressure sensitive adhesive layer has a peel adhesion to EN 1939:2003, relative to the tape (A) or to its heat-activatable adhesive layer, of not more than 5 N/cm, preferably of not more than 1 N/cm, more preferably of 0.02 N/cm to 1 N/cm, very preferably of 0.1 N/cm to 1 N/cm. This is a low peel adhesion, which corresponds to the function of adhesive tape (B) as an interliner and which therefore makes it possible for tape (B) to be removed with only minimal applied force from the heat-activatable adhesive layer of tape (A). The peel adhesion, however, is sufficient to provide a composite system which can be guided stably through a cutting system and guided from that system via various deflecting rollers to a point of reel winding, and which prevents slipping or slippage of the interliner from and on the adhesive tape (A), respectively.

The pressure sensitive adhesive layer of tape (B) comprises natural rubber or poly(meth)acrylate as principal constituent. Where natural rubber is the principal constituent, the pressure sensitive adhesive layer of tape (B) preferably comprises at least one tackifier resin.

The layer construction of tape (B) preferably comprises an adhesion promoter layer between the carrier layer and the PSA layer. The corresponding adhesive tape (B) may be produced in two steps. In a first step, the carrier layer is coated with a release varnish on one side thereof and with a layer of adhesion promoter on the other side thereof. In the second step, the PSA layer is applied to the adhesion promoter layer.

A further subject of the invention is a method for producing a composite system of the invention, which comprises the following steps:
a) cutting a composite wound to a roll and composed of
   an adhesive tape (A) comprising
      a pressure sensitive adhesive layer and
      a heat-activatable adhesive layer; and
   a release liner situated on the pressure sensitive adhesive layer of the tape (A)
   such that a plurality of rolls are obtained from a parent roll, the rolls having a web width lower than that of the parent roll;
b) unrolling the rolls and covering a plurality of the resultant webs with an adhesive tape (B) comprising
   a carrier layer,
   a release layer on one side of the carrier layer, and
   a pressure sensitive adhesive layer on the side of the carrier layer opposite from the release layer
      such that the pressure sensitive adhesive layer of the tape (B) is in direct contact with the heat-activatable adhesive layer of the tape (A);
c) cutting the tape (B) so as to form separate composite systems composed of tape (B), tape (A) and release liner, which can be wound back into rolls; where the tape (B) has a peel adhesion of not more than 5 N/cm, determined to EN 1939:2003, to the heat-activatable adhesive layer of the tape (A).

The invention also has as its subject the use of an adhesive tape (B) which comprises
a carrier layer,
a release layer on one side of the carrier layer, and
a pressure sensitive adhesive layer on the side of the carrier layer opposite from the release layer
   to cover a material in web form which is non-adhesively furnished on both sides, during the winding of this material to a roll and/or during the storage of that roll, where the pressure sensitive adhesive layer of the tape (B) is in direct contact with one of the non-adhesively furnished sides of the material in web form. In particular, one side of the double-sidedly non-adhesively furnished material in web form is a heat-activatable adhesive layer, and the pressure sensitive adhesive layer of tape (B) is located in direct contact with this heat-activatable adhesive layer.

### EXAMPLE

For producing the adhesive tape (A) in the sense of the present invention, a blown polypropylene film 40 μm thick was subjected on one side to CO₂ corona treatment and was laminated by the side thus treated to a commercially available, double-sided acrylate foam adhesive tape (tesa® ACXplus 6808). A corresponding parent roll was unrolled, and a plurality of webs 8 mm wide were cut from the web and placed alongside one another. As adhesive tape (B) in the sense of the present invention (interliner), a commercially available adhesive strapping tape (tesa® Strapping 51128), based on a soft MOPP film provided on its reverse with a carbamate release layer, and on a natural rubber adhesive, was applied to the blown polypropylene film of each web (adhesive side of the strapping tape against the blown polypropylene film) in such a way that the strapping tape initially covered all of the webs comprehensively. The resulting assembly was passed through a further cutting unit. After it had passed through the cutting unit, individual webs of the 8 mm wide composite of tesa® ACXplus 6808 and the blown polypropylene film were present, lined with a 19 mm-wide web of the strapping tape in such a way that the strapping tape overhung by 5.5 mm on each side.

The peel adhesion between strapping tape and the composite made from tesa® ACXplus 6808 and the blown polypropylene film was found according to EN 1939:2003 to be 0.9 N/cm.

### COMPARATIVE EXAMPLE

For producing the adhesive tape (A) in the sense of the present invention, a blown polypropylene film 40 μm thick was subjected on one side to CO₂ corona treatment and was laminated by the side thus treated to a commercially available, double-sided acrylate foam adhesive tape (tesa® ACXplus 6808). A corresponding parent roll was unrolled, and a plurality of webs 8 mm wide were cut from the web and placed alongside one another. As interliner, an LDPE film 55 μm thick, coated on one side with a UV-crosslinked, solventlessly applied silicone release layer, was applied to the blown polypropylene film of each web in such a way that the interliner initially covered all of the webs comprehensively. The resulting assembly was passed through a further cutting unit. After it had passed through the cutting unit, individual webs of the 8 mm wide composite of tesa® ACXplus 6808 and the blown polypropylene film were present, lined with a 19 mm-wide web of the interliner in such a way that the interliner overhung by 5.5 mm on each side.

From the composite formed from an adhesive tape and interliner of the inventive example, the individual webs could be cut in dimensionally stable form, without problems, and passed through the system. In the comparative example, irregularities occurred, meaning that the specified width of the overhanging interliner should be regarded more as a target variable and less as the value actually achieved consistently.

The respective webs obtained from the inventive example and the comparative example were lattice-wound to give reels having a web length of 1400 m, which had a reel core overhang of 2 cm at each end. The reels were packed into cartons, 5 such cartons were stacked together, and 6 such stacks were joined to one another using a film. These assemblies were transported on the loading area of a vehicle over an identical distance of 10 km. The condition of the reels was then evaluated. It was found that the reels of the invention were completely intact and exhibited still, in particular, the overhang of the reel core at both ends, and also a stable winding.

The wound webs of the comparative example, in contrast, had slipped downwards, meaning that the reel core overhang was now still present only at the upper end. The wound plies had become partly inserted in one another, thus causing the plies to stick to one another (block); the reel could no longer be satisfactorily unwound and used.

1. Composite system comprising:
an adhesive tape (A) comprising:
a pressure sensitive adhesive layer, and
a heat-activatable adhesive layer;
a release liner situated on the pressure sensitive adhesive layer of the tape (A); and
an adhesive tape (B) comprising:
a carrier layer,
a release layer on one side of the carrier layer, and
a pressure sensitive adhesive layer on the side of the carrier layer opposite from the release layer;
where the pressure sensitive adhesive layer of the tape (B) is in direct contact with the heat-activatable adhesive layer of the tape (A), and the tape (B) has a peel adhesion of not more than 5 N/cm, determined to EN 1939:2003, to the heat-activatable adhesive layer of the tape (A).

2. Composite system according to claim 1, wherein the pressure sensitive adhesive layer of the tape (A) comprises poly(meth)acrylate as principal constituent.

3. Composite system according to claim 1, wherein the tape (A) comprises a foamed pressure sensitive adhesive layer.

4. Composite system according to claim 3, wherein the foamed pressure sensitive adhesive layer of the tape (A) comprises at least partially expanded hollow microspheres.

5. Composite system according to claim 3, wherein the foamed pressure sensitive adhesive layer is the pressure sensitive adhesive layer of the tape (A).

6. Composite system according to claim 3, wherein the foamed pressure sensitive adhesive layer of the tape (A) is a carrier layer, with the heat-activatable adhesive layer arranged on one side thereof and the pressure sensitive adhesive layer arranged on the other side thereof.

7. Composite system according to claim 1, wherein the heat-activatable adhesive layer of the tape (A) is a polyolefin layer.

8. Composite system according to claim 1, wherein the tape (B) is broader than the tape (A) and broader than the release liner situated on the pressure sensitive adhesive layer thereof, and overhangs the tape (A) and the release liner on both sides.

9. Composite system according to claim 1, wherein the carrier layer of the tape (B) is a polyolefin film.

10. Composite system according to claim 1, wherein the pressure sensitive adhesive layer of the tape (B) comprises natural rubber or poly(meth)acrylate as principal constituent.

11. Method for producing a composite system according to claim 1, comprising the following steps:
a) cutting a composite wound to a roll and composed of:
an adhesive tape (A) comprising:
a pressure sensitive adhesive layer, and
a heat-activatable adhesive layer; and
a release liner situated on the pressure sensitive adhesive layer of the tape (A)
such that a plurality of rolls are obtained from a parent roll, the rolls having a web width lower than that of the parent roll;
b) unrolling the rolls and covering a plurality of the resultant webs with an adhesive tape (B) comprising:
a carrier layer,
a release layer on one side of the carrier layer, and
a pressure sensitive adhesive layer on the side of the carrier layer opposite from the release layer;
such that the pressure sensitive adhesive layer of the tape (B) is in direct contact with the heat-activatable adhesive layer of the tape (A);
c) cutting the tape (B) so as to form separate composite systems composed of tape (B), tape (A) and release liner, which can be wound back into rolls;
where the tape (B) has a peel adhesion of not more than 5 N/cm, determined to EN 1939:2003, to the heat-activatable adhesive layer of the tape (A).

12. Method of covering a material in web form which is non-adhesively furnished on both sides, during the winding of this material to a roll and/or during the storage of that roll, said method comprising covering said material in web form with an adhesive tape (B) comprising:
a carrier layer,
a release layer on one side of the carrier layer, and
a pressure sensitive adhesive layer on the side of the carrier layer opposite from the release layer,
where the pressure sensitive adhesive layer of the tape (B) is in direct contact with one of the non-adhesively furnished sides of the material in web form.
